(19) United States
(12) Patent Application Publication
(10) Pub. No.: US 2001/0018757 A1
(43) Pub. Date: Aug. 30, 2001

(54) Method of layouting semiconductor integrated circuit and apparatus for doing the same

(76) Inventor: Nobuhito Morikawa, Kanagawa (JP)

Correspondence Address: McGinn & Gibb, PLLC, Suite 200, 8321 Old Courthouse Road, Vienna, VA, 22182-3817, US

(21) Appl. No.: 09/790,550

(22) Filed: Feb. 23, 2001

(30) Foreign Application Priority Data
Feb. 25, 2000 (JP) 049123/2000

(51) Int. Cl. G06F 17/50; G06F 9/45

(52) U.S. Cl. 716/5; 716/11

(57) ABSTRACT

A method of layouting a semiconductor integrated circuit comprised of a plurality of cells, including the steps of (a) inputting first data and second data into an automatic layout system, the first data relating to connection of a circuit, the second data relating to the cells and a fill cell which is to be positioned at a space formed between the cells and includes a protection circuit for preventing a wiring electrically connecting the cells to each other from being charged, (b) arranging the cells, based on the first and second data, (c) positioning the fill cell in a space formed between the cells, (d) checking whether there is caused antenna effect due to the wiring being charged, and transmitting a check signal identifying a wiring which needs to be protected from the antenna effect, and (e) carrying out a process for preventing the antenna effect, to the wiring identified with the check signal.

### BACKGROUND OF THE INVENTION

1. Field of the Invention

The invention relates to a method of layouting a semiconductor integrated circuit, and more particularly to such a method of mask layouting a semiconductor integrated circuit with prevention of antenna effect caused by a wiring being charged.

2. Description of the Related Art

As a gate size in a semiconductor integrated circuit such as LSI is increasing and increasing, a gate size in which a wiring arrangement is carried out by means of an automatic layout system is also increasing and increasing. This results in that a wiring in a process unit may become quite long, in which case, an insulating film such as a gate insulating film is likely to be damaged, specifically, be degraded or go to dielectric breakdown due to electric charges occurring in a plasma or ion beam process in fabrication of LSI.

In addition, there occurs so-called antenna effect. In the antenna effect, a wiring layer electrically connected to an electrically conductive film formed on an insulating film is charged with the result that a lot of electric charges are accumulated in the electrically conductive film. If such antenna effect occurs, an insulating film such as the above-mentioned one is readily damaged.

In order to prevent the above-mentioned antenna effect, many attempts have been made.

For instance, Japanese Unexamined Patent Publication No. 11-186394 has suggested a method of fabricating a semiconductor integrated circuit, in which an uppermost wiring cell is inserted into a wiring which needs to be protected from the antenna effect, to thereby define a wiring length equal to or smaller than a predetermined length, ensuring preventing an insulating film from being damaged by the antenna effect.

FIGS. 1 to 3 illustrate the steps to be carried out in the suggested method. FIG. 1 illustrates a layout of a semiconductor integrated before protection against the antenna effect is made, FIG. 2 illustrates a pattern for making protection against the antenna effect, and FIG. 3 illustrates a layout of a semiconductor integrated after protection against the antenna effect is made.

As illustrated in FIG. 1, a target wiring 101 which needs to be protected from the antenna effect is connected to a pin 104 of a cell 103 through a wiring 102. Herein, the target wiring 101 and the wiring 102 are not uppermost wirings in a layout.

As a solution to the antenna effect problem, there is used an uppermost wiring cell 105 as illustrated in FIG. 2. In the uppermost wiring cell 105, pins 106 and 107 are connected to each other through an uppermost wiring 108. By combining a structure illustrated in FIG. 1 to a structure illustrated in FIG. 2, there is obtained a pattern as a protection against the antenna effect.

That is, as illustrated in FIG. 3, the uppermost wiring cell 105 is located above the cell 103. The pins 104 and 106 are electrically connected to each other through a wiring 102a which is not an uppermost wiring. The target wiring 101 and the pin 107 are electrically connected to each other through a wiring which is not an uppermost wiring. The structure illustrated in FIG. 3 accomplishes a protection against the antenna effect.

Japanese Unexamined Patent Publication No. 11-214521 has suggested a semiconductor integrated circuit characterized in that a protection element is electrically connected to a floating gate of a primitive cell.

FIG. 4 is a circuit diagram of an inverter cell 110 including a protection circuit, included in the suggested semiconductor integrated circuit.

The inverter cell 110 is comprised of an inverter 111 and a protection circuit 112. Not only the inverter 111, but also all primitive cells such as NOR and NAND are designed to include a protection circuit to ensure a protection against the antenna effect to all wirings.

However, the semiconductor integrated circuit illustrated in FIGS. 1 to 3 is accompanied with a problem that if an uppermost wiring becomes complicated in structure with an increase in a size of LSI, it might not be possible to arrange the uppermost wiring cell in such a manner as illustrated in FIG. 3.

The semiconductor integrated circuit illustrated in FIG. 4 is accompanied with a problem that since even a wiring which does not need to be protected from the antenna effect is designed to include a protection circuit, a layout area is unavoidably increased, resulting in an increase in an area of a semiconductor chip. This problem would be remarkable with an increase in a scale of LSI.

Japanese Unexamined Patent Publication No. 6-326248 has suggested a semiconductor integrated circuit including a semiconductor substrate on which cells each having a MOS transistor are arranged, and wirings electrically connected to the cells to one another to thereby perform a desired function. The semiconductor substrate is formed at a surface thereof with a pn junction comprised of a p-type region and an n-type region located remoter from a surface of the semiconductor substrate from the p-type region. Diode sequences are spaced away from one another at a constant interval. Each of the diode sequences is comprised of a pn junction sequence including pn junctions arranged in a wiring truck perpendicular to a wiring connecting cells to each other, and an electrode filled in a contact hole formed from a wiring layer to the p-type region. A wiring length between a gate of the MOS transistor and the electrode is designed to be automatically smaller than a predetermined length.

Japanese Unexamined Patent Publication No. 8-97416 has suggested a semiconductor device including a first-stage input circuit, an internal circuit including a field effect transistor, a gate electrode layer constituting the field effect transistor, a first wiring layer which is electrically connected to the gate electrode layer and which transmits a circuit signal to the gate electrode layer, and an impurity diffusion layer sandwiched between the gate electrode layer and the first wiring layer, and including a resistor and a diode.

Japanese Unexamined Patent Publication No. 8-306922 has suggested a method of fabricating a polysilicon gate of a semiconductor memory device through plasma lithography, including the steps of separately forming a gate polysilicon layer in an active region and a contact polysilicon layer in a region other than the active region, and connecting the gate polysilicon layer and the contact polysilicon layer to each other through an electrical conductor.

Japanese Unexamined Patent Publication No. 10-144795, which is based on U.S. patent application Ser. No. 740,766 filed by Daniel R. Cronyn III on Nov. 1, 1996 and assigned to Motorola Incorporated, has suggested a standard cell library including a plurality of standard cells. At least one of the standard cells is comprised of a standard cell input, and a holder associated with the standard cell input for positioning a diode therein. The diode positioned in the holder is electrically connected to the standard cell input.

Japanese Unexamined Patent Publication No. 11-186394 has suggested a method of fabricating a semiconductor integrated circuit, including the step of inserting a standard cell to a wiring electrically connected to a gate electrode to cause the wiring to have such a predetermined length as preventing a gate oxide film from being degraded. The standard cell to be inserted includes a wiring passing through an uppermost wiring layer in the standard cell.

Japanese Unexamined Patent Publication No. 11-297836 has suggested a semiconductor device including cells and functional blocks or modules arranged in combination, and a wiring pattern connecting the cells and functional blocks or modules to each other therethrough. Each of the cells and the functional blocks is comprised of a first diffusion layer having a first electrical conductivity and electrically connected to an input terminal thereof, and a diode having a first electrical conductivity and including a well electrically connected to a second voltage source and having a second electrical conductivity.

Japanese Unexamined Patent Publication No. 11-186502 has suggested a semiconductor device including a plurality of standard cells formed on a semiconductor substrate and each having an input terminal and a MOS transistor. The semiconductor device further includes a diffusion region formed in the semiconductor substrate and having almost ignorable resistance. The input terminal and the gate are electrically connected to each other through a wiring including the diffusion region.

However, the above-mentioned problems remain unsolved even in the above-mentioned Publications.

### SUMMARY OF THE INVENTION

In view of the above-mentioned problems in the prior art, it is an object of the present invention to provide a method of layouting a semiconductor integrated circuit which method is capable of readily accomplishing a countermeasure against the antenna effect.

It is also an object of the present invention to provide an apparatus for layouting a semiconductor integrated circuit which apparatus is capable of doing the same.

In one aspect of the present invention, there is provided a method of layouting a semiconductor integrated circuit comprised of a plurality of cells, including the step of positioning a fill cell at a space formed between the cells, the fill cell including a protection circuit for preventing a wiring electrically connecting the cells to each other from being charged.

For instance, the protecting circuit may be comprised of a diode.

It is preferable that the fill cell has a region through which a wiring electrically connecting the cells to each other is arranged.

The method may further include the steps of checking whether there is caused antenna effect due to the wiring being charged, and electrically connecting a wiring which needs to be protected from the antenna effect, to the protection circuit.

For instance, a wiring which needs to be protected from antenna effect may be electrically connected across the diode and a grounded line.

For instance, a wiring which needs to be protected from antenna effect may be electrically connected across a source voltage line and a grounded line.

The method may further include the steps of forming a cell having an opening pattern through which wirings are electrically connected to each other, and arranging the cell on the protection circuit.

The method may further include the steps of, if the fill cell is not located in the vicinity of a wiring which needs to be protected from antenna effect, shifting at least one space formed between the cells, to the vicinity of the wiring.

There is further provided a method of layouting a semiconductor integrated circuit comprised of a plurality of cells, including the steps of (a) inputting first data and second data into an automatic layout system, the first data relating to connection of a circuit, the second data relating to the cells and a fill cell which is to be positioned at a space formed between the cells and includes a protection circuit for preventing a wiring electrically connecting the cells to each other from being charged, (b) arranging the cells, based on the first and second data, (c) positioning the fill cell in a space formed between the cells, (d) checking whether there is caused antenna effect due to the wiring being charged, and transmitting a check signal identifying a wiring which needs to be protected from the antenna effect, and (e) carrying out a process for preventing the antenna effect, to the wiring identified with the check signal.

The method may further include the steps of (f) checking whether there exists the fill cell below the wiring identified with the check signal or in the vicinity of the wiring, and (g) connecting the wiring to the fill cell, if the fill cell is judged to exist in the step (f).

The method may further include the steps of (f) checking whether there exists the fill cell below the wiring identified with the check signal or in the vicinity of the wiring, (g) if the fill cell is judged not to exist in the step (f), retrieving a space in which the fill cell is to be positioned and which is located on the wiring identified with the check signal or in the vicinity of the wiring, (h) shifting the cell such that the wiring can be connected to the fill cell, and (i) compensating for breakage in the wiring caused by the step (h).

The method may further include the step of (j) defining an area in which the space is to be retrieved, the step (j) being to be carried out before the step (g).

It is preferable that the area is comprised of a horizontally extending area and a vertically extending area.

In another aspect of the present invention, there is provided an apparatus for layouting a semiconductor integrated circuit comprised of a plurality of cells, including (a) a first memory including first data relating to connection of a circuit, (b) a second memory including second data relating to the cells and a fill cell which is to be positioned at a space formed between the cells and includes a protection circuit for preventing a wiring electrically connecting the cells to each other from being charged, (c) an automatic layout system which arranges the cells, based on the first and second data, and positions the fill cell in a space formed between the cells, and (d) an electronic design automation tool which checks whether there is caused antenna effect due to the wiring being charged, and transmits a check signal identifying a wiring which needs to be protected from the antenna effect, the automatic layout system carrying out a process for preventing the antenna effect, to the wiring identified with the check signal.

It is preferable that the automatic layout system checks whether there exists the fill cell below the wiring identified with the check signal or in the vicinity of the wiring, and connects the wiring to the fill cell, if the fill cell is judged to exist.

It is preferable that the automatic layout system (a) checks whether there exists the fill cell below the wiring identified with the check signal or in the vicinity of the wiring, (b) retrieves a space in which the fill cell is to be positioned and which is located on the wiring identified with the check signal or in the vicinity of the wiring, if the fill cell is judged not to exist, (c) shifts the cell such that the wiring can be connected to the fill cell, and (d) compensates for breakage in the wiring caused by shifting the cell.

It is preferable that the automatic layout system defines an area in which the space is to be retrieved before actually retrieving the space.

In still another aspect of the present invention, there is provided a semiconductor integrated circuit comprised of a plurality of cells, including (a) a semiconductor substrate including protection elements formed therein, the protection elements each including a first diffusion layer formed at a surface of the substrate and a second diffusion layer around the first diffusion layer, the first diffusion layer having a first electrical conductivity and the second diffusion layer having a second electrical conductivity, (b) a grounded line electrically connecting to the second diffusion layer through a contact hole, (c) a voltage source line electrically connecting to a third diffusion layer formed at a surface of the substrate, through a contact hole, the third diffusion layer having a first electrical conductivity, the grounded line and the voltage source line both being comprised of a first metal wiring layer, and (d) a target wiring which is comprised of the first metal wiring layer and needs to be protected from antenna effect, one of the protection elements being located just below the target wiring, the target wiring being electrically connected to the first diffusion layer of the one of protection elements through a contact hole.

There is further provided a semiconductor integrated circuit comprised of a plurality of cells, including (a) a semiconductor substrate including protection elements formed therein, the protection elements each including a first diffusion layer formed at a surface of the substrate and a second diffusion layer around the first diffusion layer, the first diffusion layer having a first electrical conductivity and the second diffusion layer having a second electrical conductivity, (b) a grounded line electrically connecting to the second diffusion layer through a contact hole, (c) a voltage source line electrically connecting to a third diffusion layer formed at a surface of the substrate, through a contact hole, the third diffusion layer having a first electrical conductivity, the grounded line and the voltage source line both being comprised of a first metal wiring layer, (d) a target wiring which is comprised of the first metal wiring layer and needs to be protected from antenna effect, and (e) a connector wiring having a first end located just above one of the protection elements located in the vicinity of the target wiring, and a second end at which the connector wiring is electrically connected to the target wiring, the connector wiring being electrically connected at the first end to the first diffusion layer of the one of protection elements through a contact hole.

There is further provided a semiconductor integrated circuit comprised of a plurality of cells, including (a) a semiconductor substrate including protection elements formed therein, the protection elements each including a first diffusion layer formed at a surface of the substrate and a second diffusion layer around the first diffusion layer, the first diffusion layer having a first electrical conductivity and the second diffusion layer having a second electrical conductivity, (b) a grounded line electrically connecting to the second diffusion layer through a contact hole, (c) a voltage source line electrically connecting to a third diffusion layer formed at a surface of the substrate, through a contact hole, the third diffusion layer having a first electrical conductivity, the grounded line and the voltage source line both being comprised of a first metal wiring layer, (d) a target wiring which is comprised of a second metal wiring layer located above the first metal wiring layer, and which needs to be protected from antenna effect, and (e) a connector wiring comprised of the first metal wiring layer, at least one of the protection elements being located just below the target wiring, the target wiring being electrically connected to the connector wiring through a first contact hole, and the connector wiring being electrically connected to the first diffusion layer of the one of protection elements through a second contact hole.

There is further provided a semiconductor integrated circuit comprised of a plurality of cells, including (a) a semiconductor substrate including protection elements formed therein, the protection elements each including a first diffusion layer formed at a surface of the substrate and a second diffusion layer around the first diffusion layer, the first diffusion layer having a first electrical conductivity and the second diffusion layer having a second electrical conductivity, (b) a grounded line electrically connecting to the second diffusion layer through a contact hole, (c) a voltage source line electrically connecting to a third diffusion layer formed at a surface of the substrate, through a contact hole, the third diffusion layer having a first electrical conductivity, the grounded line and the voltage source line both being comprised of a first metal wiring layer, (d) a target wiring which is comprised of a second metal wiring layer located above the first metal wiring layer, and which needs to be protected from antenna effect, and (e) a connector wiring which is comprised of the first metal wiring layer and which has a first end located just below the target wiring and a second end located just above one of the protection elements, the connector wiring being electrically connected at the first end to the target wiring through a first contact hole, and being electrically connected at the second end to the first diffusion layer of the one of protection elements through a second contact hole.

There is still further provided a semiconductor integrated circuit including (a) a plurality of macro cells, (b) a target wiring which needs to be protected from antenna effect and which electrically connects a driver cell located in one of the macro cells to a gate electrode cell located in another one of the macro cells, the target wiring passing through a space defined between the macro cells, the space being filled with fill cells each including a protection circuit for preventing antenna effect, the target wiring being electrically connected to a fill cell located closest to the gate electrode cell.

The advantages obtained by the aforementioned present invention will be described hereinbelow.

In accordance with the present invention, a fill cell including a protection circuit for preventing a wiring from being charged is positioned in a space formed between cells constituting a semiconductor integrated circuit. For instance, the protection circuit may be comprised of a diode. It is checked whether there occurs the antenna effect in any of the wirings, due to a wiring being charged. A wiring which is charged, that is, which needs to be protected from the antenna effect is electrically connected to the protection circuit of the fill cell.

If a fill cell is not located in the vicinity of a wiring which needs to be protected from the antenna effect, a space or spaces formed between the cells is (are) shifted to the vicinity of the wiring.

As a result, it would be possible to accomplish a countermeasure against the antenna effect without an increase in a layout area of LSI, that is, an area of a semiconductor chip. This advantage becomes more remarkable with an increase in a scale of LSI, ensuring higher integration and multi-function in LSI.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIGS. 1, 2 and 3 are plan views of a layout of a semiconductor integrated circuit in accordance with the first prior art.

FIG. 4 is a plan view of a cell of a semiconductor integrated circuit in accordance with the second prior art.

FIG. 5 is a block diagram of an apparatus of layouting a semiconductor integrated device, in accordance with the first embodiment of the present invention.

FIG. 6 is a flow-chart showing the steps to be carried out in the apparatus illustrated in FIG. 5.

FIG. 7 is a flow-chart showing the steps to be carried out in the apparatus illustrated in FIG. 5.

FIG. 8A is a plan view of a fill cell in the present invention.

FIG. 8B is a cross-sectional view taken along the line 8B-8B in FIG. 8A.

FIG. 9A is a plan view of a semiconductor integrated circuit in accordance with the second embodiment of the present invention.

FIG. 9B is a cross-sectional view taken along the line 9B-9B in FIG. 9A.

FIG. 10A is a plan view of a semiconductor integrated circuit in accordance with the third embodiment of the present invention.

FIG. 10B is a cross-sectional view taken along the line 10B-10B in FIG. 10A.

FIG. 11A is a plan view of a semiconductor integrated circuit in accordance with the fourth embodiment of the present invention.

FIG. 11B is a cross-sectional view taken along the line 11B-11B in FIG. 11A.

FIG. 12A is a plan view of a semiconductor integrated circuit in accordance with the fifth embodiment of the present invention.

FIG. 12B is a cross-sectional view taken along the line 12B-12B in FIG. 12A.

FIG. 13A is a plan view of a cell layout wiring.

FIG. 13B is a plan view of a cell layout wiring in accordance with the sixth embodiment of the present invention, in correspondence to FIG. 13A.

FIG. 14A is a plan view of a cell layout wiring.

FIG. 14B is a plan view of a cell layout wiring in accordance with the seventh embodiment of the present invention, in correspondence to FIG. 14A.

FIG. 15A is a plan view of a cell layout wiring.

FIG. 15B is a plan view of a cell layout wiring in accordance with the eighth embodiment of the present invention, in correspondence to FIG. 15A.

FIG. 16 is a flow-chart showing another steps to be carried out in the apparatus illustrated in FIG. 5.

FIG. 17 is a flow-chart showing another steps to be carried out in the apparatus illustrated in FIG. 5.

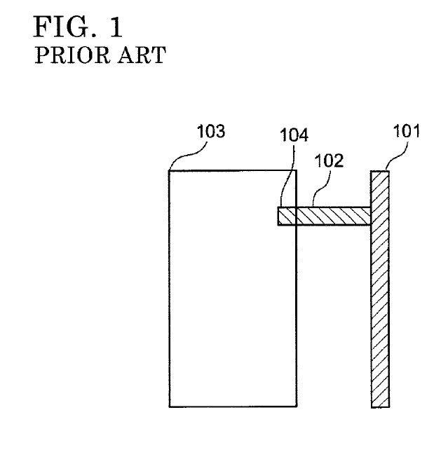

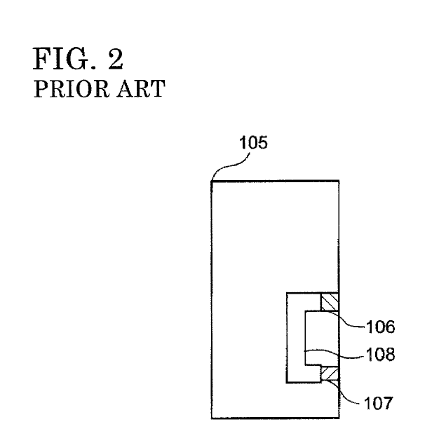

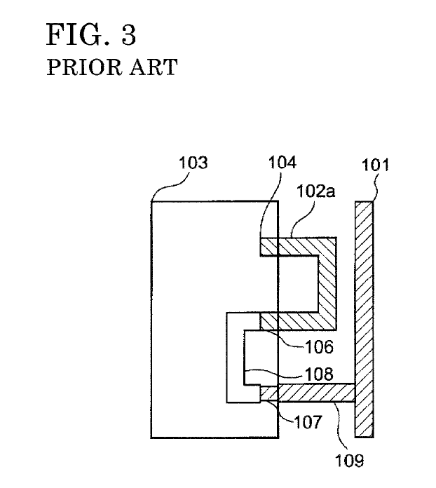

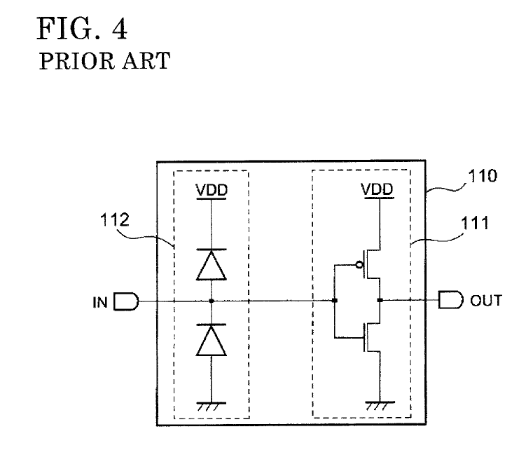

### DESCRIPTION OF THE PREFERRED EMBODIMENTS

Preferred embodiments in accordance with the present invention will be explained hereinbelow with reference to drawings.

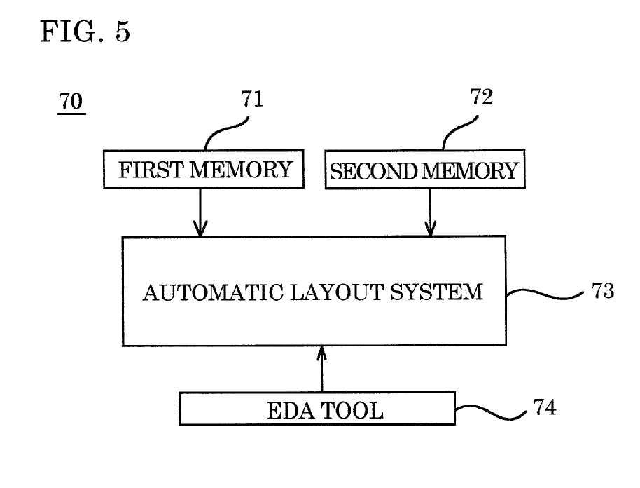

FIG. 5 is a block diagram of an apparatus of layouting a semiconductor integrated device comprised of a plurality of standard cells, in accordance with the first embodiment of the present invention.

The apparatus 70 is comprised of a first memory 71 including first data relating to connection of a circuit, a second memory 72 including second data relating to the standard cells and a fill cell which is to be positioned at a space formed between the standard cells and includes a protection circuit for preventing a wiring electrically connecting the standard cells to each other from being charged, an automatic layout system 73 which arranges the standard cells, based on the first and second data, and positions the fill cell in a space formed between the standard cells, and an electronic design automation (EDA) tool 74 which checks whether there is caused antenna effect due to the wiring being charged, and transmits a check signal to the automatic layout system 72.

The check signal identifies a wiring which needs to be protected from the antenna effect. The automatic layout system 73 carries out a process for preventing the antenna effect, to the wiring identified with the check signal.

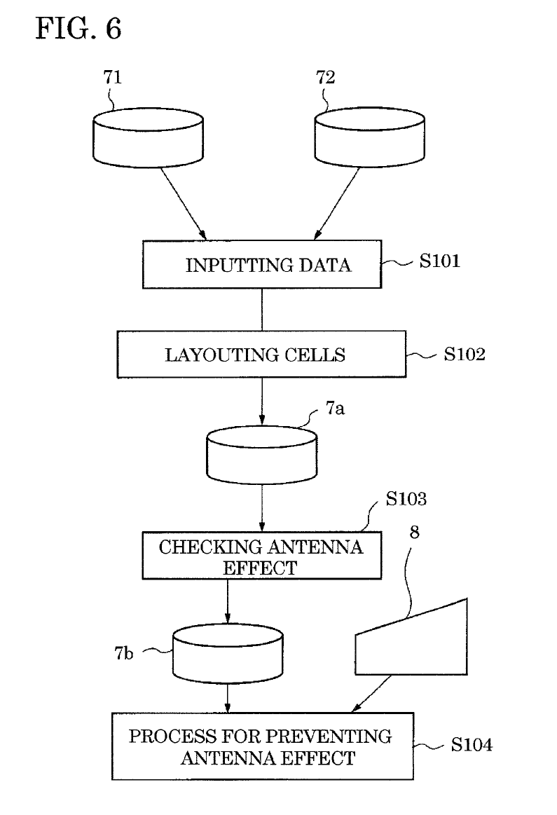

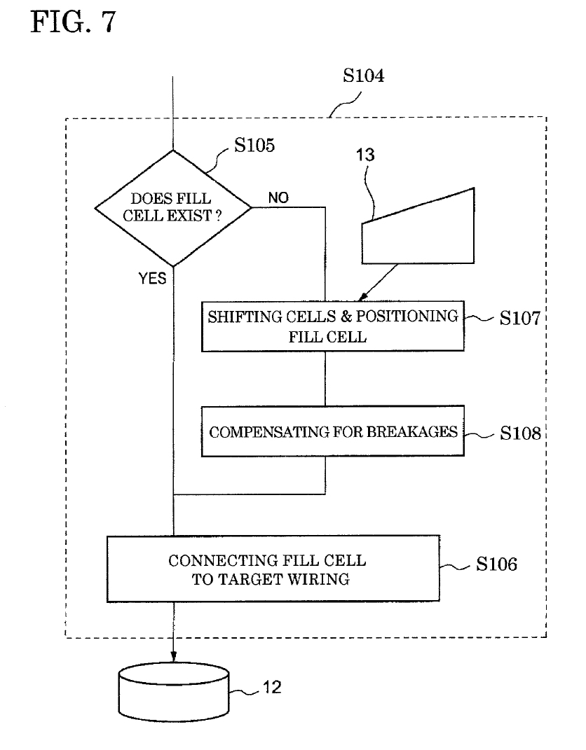

FIGS. 6 and 7 show an operation of the apparatus 70. Hereinbelow is explained an operation of the apparatus 70 with reference to FIGS. 6 and 7.

With reference to FIG. 6, the first data stored in the first memory 71 and the second data stored in the second memory 72 are input into the automatic layout system 73, in step S101. As mentioned earlier, the first data relates to circuit connection, and the second data relates to a standard cell constituting a semiconductor integrated circuit, and a fill cell which is to be positioned at a space formed between the standard cells. A fill cell will be mentioned in detail later. A standard cell includes a standard circuit such as an inverter, NOR, NAND or F/F (flip-flop).

Then, the automatic layout system 73 layouts the standard cells, and forms wirings electrically connecting standard cells to one another, based on the first and second data, in step 102.

If there is formed a space between the standard cells, the automatic layout system 73 positions a fill cell in the space, and transmits layout data 7a.

The electronic design automation tool 74 checks whether there is caused antenna effect in any of wirings, based on the layout data 7a, and transmits check data 7b to the automatic layout system 73, in step S103. The check data 7b identifies a wiring which needs to be protected from the antenna effect. Hereinafter, a wiring identified with the check data 7b as a wiring which needs to be protected from the antenna effect is referred to as a target wiring.

Then, the automatic layout system 73 carries out a process for preventing the antenna effect, to all wirings identified by the check data 7b, in step S104, based on data 8 indicative of a range in which a fill cell is to be retrieved.

The data 8 is comprised of a horizontally extending range and a vertically extending range.

The step S104 is characterized in that a fill cell is effectively used, as follows.

Hereinbelow is explained the step S104 in detail. The step S104 includes steps 105, 106, 107 and 108.

The automatic layout system 73 checks whether there exists a fill cell below the target wiring or in the vicinity of the target wiring, based on the data 8, in step S105.

If there is found a fill cell (YES in step S105), the target wiring and a fill cell located below or in the vicinity of the target wiring are electrically connected to each other by metallization and through a contact hole, in step S106.

If there is not found a fill cell (NO in step S105), data 13 indicative of an area in which a space formed between the standard cells is to be retrieved is input into the automatic layout system 73. The data 13 is comprised of first data indicating horizontally arranged standard cells in which a space formed between the standard cells is to be retrieved, and second data indicating vertically arranged standard cells in which a space formed between the standard cells is to be retrieved.

Then, the automatic layout system 73 continues a search until a space to position a fill cell therein is found below the target wiring or in the vicinity of the target wiring, based on the data 13.

Then, the automatic layout system 73 shifts some standard cells to thereby form a space, and positions a fill cell in the thus formed space, in step S107.

Then, the automatic layout system 73 compensates for breakages in wirings caused by shifting the standard cells in step S108, and electrically connects a fill cell and the target wiring to each other in step S106.

Thus, there is obtained mask data 12 relating to layout of the standard cells and wirings to which a countermeasure against the antenna effect was carried out.

Hereinbelow are explained semiconductor integrated circuits in accordance with the embodiments.

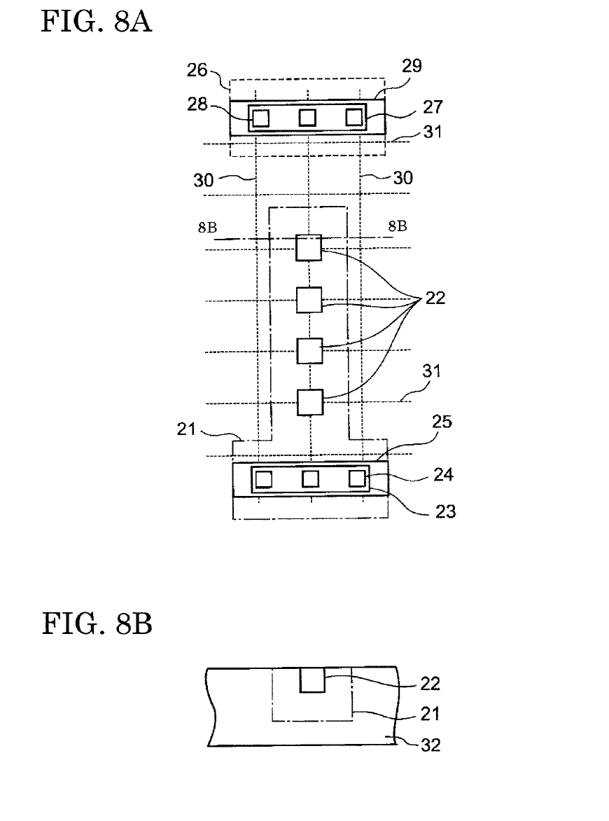

First, a structure of a fill cell is explained with reference to FIGS. 8A and 8B. FIG. 8A is a plan view of a semiconductor integrated circuit including fill cells, and FIG. 8B is a cross-sectional view taken along the line 8B-8B in FIG. 8A.

As illustrated in FIG. 8A, the semiconductor integrated circuit includes a semiconductor substrate 32 (see FIG. 8B) having a p-type well layer 21 and a plurality of n-type diffusion layers 22 formed in the p-type well layer 21. A p-type diffusion layer 23 is formed making electrical contact with the p-type well layer 21. The p-type diffusion layer 23 is electrically connected to a grounded line 25 through a contact hole 24.

The semiconductor substrate 32 includes an n-type well layer 26, and an n-type diffusion layer 27 making electrical contact with the n-type well layer 26. A voltage source line 29 is electrically connected to the n-type diffusion layer 27 through a contact hole 28.

Both of the grounded line 25 and the voltage source line 29 are comprised of a first metal wiring layer.

A fill cell including a protection device has three vertical layout tracks 30 and seven horizontal layout tracks 31.

The protection device in a fill cell is comprised of an N-P junction diode. Specifically, as illustrated in FIG. 8B, the p-type well layer 21 formed at a surface of the semiconductor substrate 32 and the n-type diffusion layer 22 formed in the p-type well layer 21 constitute a diode as the protection device.

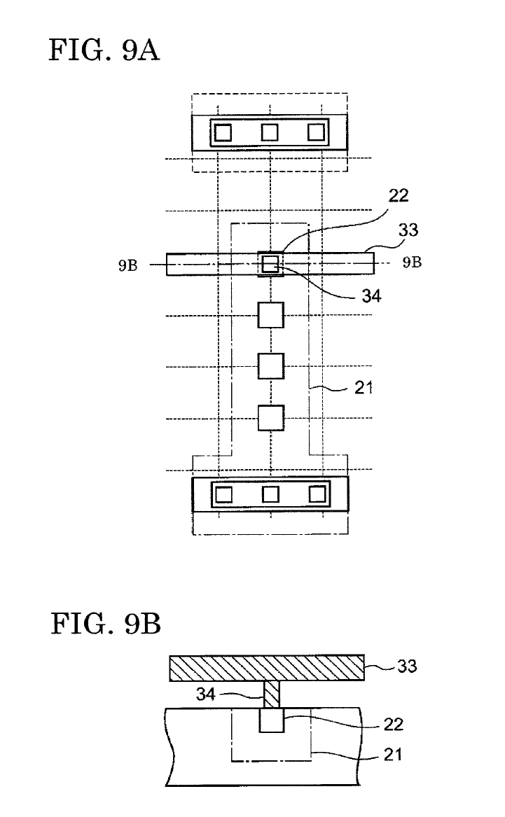

FIGS. 9A and 9B illustrate a semiconductor integrated circuit in accordance with the second embodiment of the present invention. FIG. 9A is a plan view of the semiconductor integrated circuit, and FIG. 9B is a cross-sectional view taken along the line 9B-9B in FIG. 9A.

Parts or elements that correspond to those of the semiconductor integrated circuit illustrated in FIGS. 8A and 8B have been provided with the same reference numerals.

In the second embodiment, one of the fill cells is located just below a target wiring 33 which is comprised of the first metal wiring layer. As illustrated in FIG. 9B, the target wiring 33 is electrically connected to the n-type diffusion layer 22 of the diode through a contact hole 34. A cell having a pattern defining the contact hole 34 is automatically positioned by the automatic layout system 73.

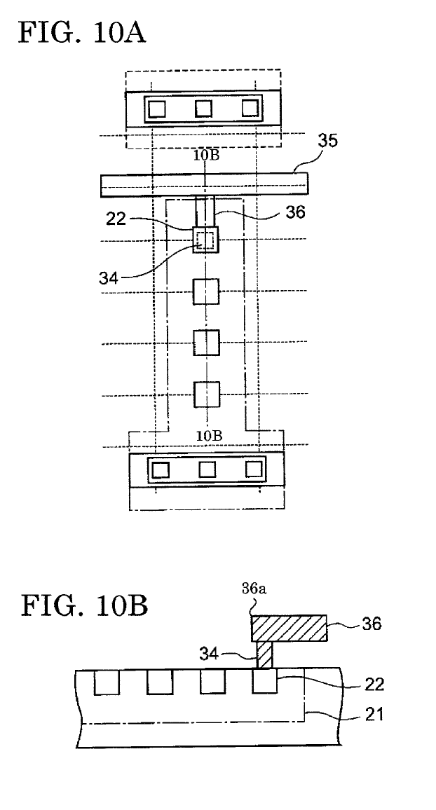

FIGS. 10A and 10B illustrate a semiconductor integrated circuit in accordance with the third embodiment of the present invention. FIG. 10A is a plan view of the semiconductor integrated circuit, and FIG. 10B is a cross-sectional view taken along the line 10B-10B in FIG. 10A.

Parts or elements that correspond to those of the semiconductor integrated circuit illustrated in FIGS. 8A and 8B have been provided with the same reference numerals.

In the third embodiment, one of the fill cells is located in the vicinity of a target wiring 35 which is comprised of the first metal wiring layer.

The semiconductor integrated circuit in accordance with the third embodiment is designed to include a connector wiring 36 having a first end 36a located just above one of the fill cells located closest to the target wiring 35, and a second end at which the connector wiring 36 is electrically connected to the target wiring 35. As best illustrated in FIG. 10B, the connector wiring 36 is electrically connected at the first end 36a to the first diffusion layer 22 of the fill cell through a contact hole 34.

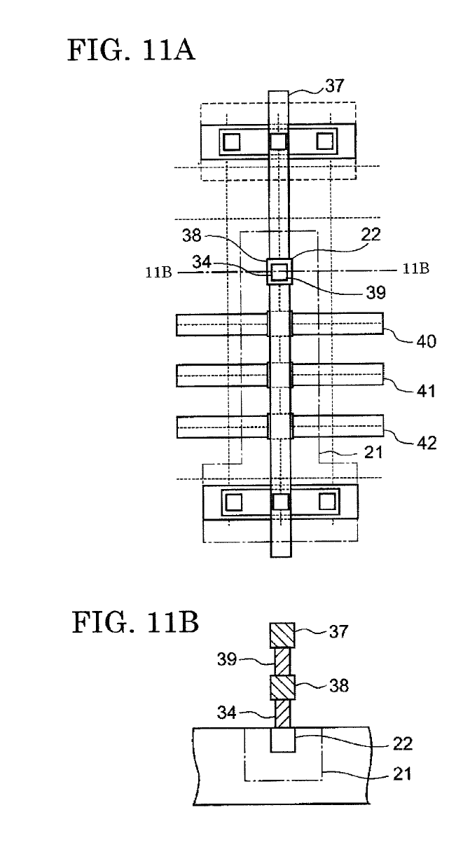

FIGS. 11A and 11B illustrate a semiconductor integrated circuit in accordance with the fourth embodiment of the present invention. FIG. 11A is a plan view of the semiconductor integrated circuit, and FIG. 11B is a cross-sectional view taken along the line 11B-11B in FIG. 11A.

In the fourth embodiment, a target wiring 37 is comprised of a second metal wiring layer located above the first metal wiring layer. All of the fill cells are located below the target wiring 37.

The semiconductor integrated circuit in accordance with the fourth embodiment is designed to include a connector wiring 38 comprised of the first metal wiring layer which is located below the second metal wiring layer.

As illustrated in FIG. 11B, the target wiring 37 is electrically connected to the connector wiring 38 through a first contact hole 39, and the connector wiring 38 is electrically connected to the first diffusion layer 22 of the fill cell through a second contact hole 34. That is, the target wiring 37 is electrically connected to the first diffusion layer 22 through the first contact hole 39, the connector wiring 38 and the second contact hole 34.

Wirings 40, 41 and 42 all comprised of the first metal wiring layer extend above the p-type well layer 21, but below the target wiring 37.

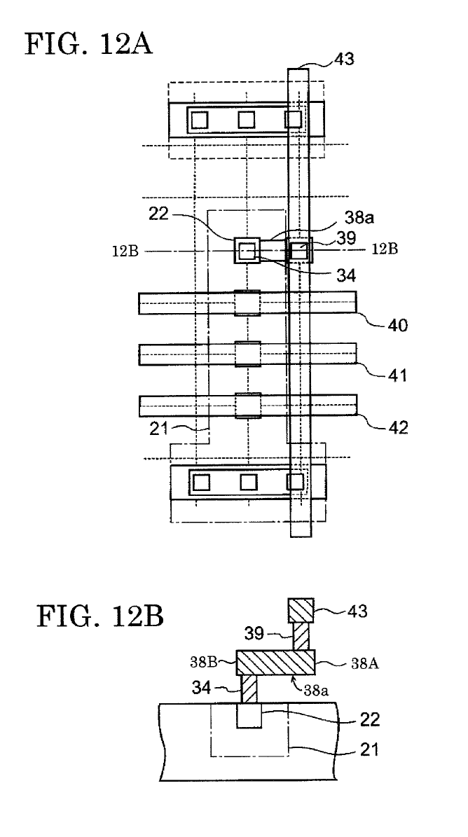

FIGS. 12A and 12B illustrate a semiconductor integrated circuit in accordance with the fifth embodiment of the present invention. FIG. 12A is a plan view of the semiconductor integrated circuit, and FIG. 12B is a cross-sectional view taken along the line 12B-12B in FIG. 12A.

Parts or elements that correspond to those of the semiconductor integrated circuit illustrated in FIGS. 11A and 11B have been provided with the same reference numerals.

In the fifth embodiment, a target wiring 43 is comprised of a second metal wiring layer located above the first metal wiring layer. The fill cells are located in the vicinity of the target wiring 43.

The semiconductor integrated circuit in accordance with the fifth embodiment is designed to include a connector wiring 38a comprised of the first metal wiring layer which is located below the second metal wiring layer. The connector wiring 38a has a first end 38A located just below the target wiring 43 and a second end 38B located just above one of the fill cells.

As illustrated in FIG. 12B, the connector wiring 38a is electrically connected at the first end 38A to the target wiring 43 through a first contact hole 39, and is further electrically connected at the second end 38B to the first diffusion layer 22 of the fill cell through a second contact hole 34. That is, the target wiring 43 is electrically connected to the first diffusion layer 22 through the first contact hole 39, the connector wiring 38a and the second contact hole 34.

Wirings 40, 41 and 42 all comprised of the first metal wiring layer extend above the p-type well layer 21, but below the target wiring 43.

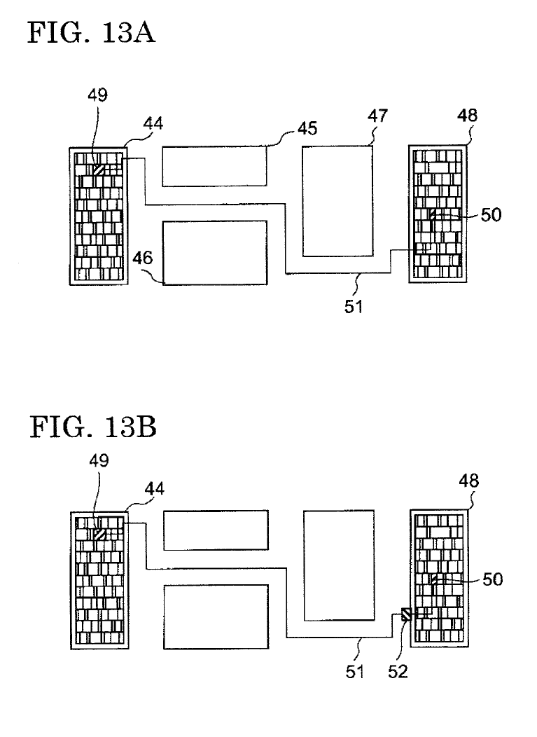

FIGS. 13A and 13B illustrate a semiconductor integrated circuit in accordance with the sixth embodiment of the present invention. FIG. 13A is a plan view of a cell layout of the semiconductor integrated circuit before a countermeasure against the antenna effect is carried out, and FIG. 13B is a plan view of a cell layout of the same after a countermeasure against the antenna effect has been carried out.

In the sixth embodiment, macro cells are arranged in a semiconductor chip unlike the above-mentioned second to fifth embodiments.

As illustrated in FIG. 13A, a first macro cell 44, a second macro cell 45, a third macro cell 46, a fourth macro cell 47, and a fifth macro cell 48 are arranged in a semiconductor chip. A target wiring 51 which needs to be protected from the antenna effect electrically connects a driver cell 49 arranged in the first macro cell 44 to a gate electrode cell 50 arranged in the fifth macro cell 48 through a wiring channel defined among the second macro cell 45, the third macro cell 46 and the fourth macro cell 47.

The standard cells are not arranged in the wiring channel. Instead, the wiring channel is filled with the fill cells. Hence, as illustrated in FIG. 13B, it is possible to electrically connect the target wiring 51 to a fill cell 52 which is located within the wiring channel and further closest to the gate electrode cell 50.

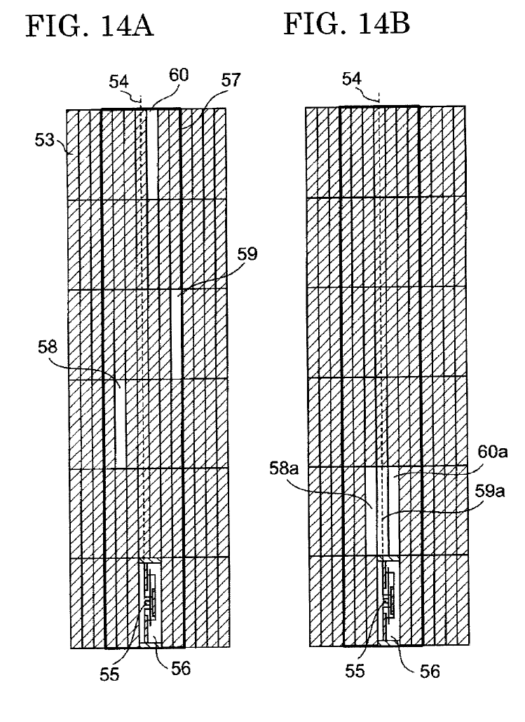

FIGS. 14A and 14B illustrate a semiconductor integrated circuit in accordance with the seventh embodiment of the present invention. FIG. 14A is a plan view of a cell layout of the semiconductor integrated circuit before a countermeasure against the antenna effect is carried out, and FIG. 14B is a plan view of a cell layout of the same after a countermeasure against the antenna effect has been carried out.

In the seventh embodiment, as mentioned below, standard cells are shifted to define a space in a desired area into which a fill cell is to be positioned. FIGS. 14A and 14B are not entire views of a unit of automatic layout, but partial views of the same.

As illustrated in FIG. 14A, the automatic layout system 73 arranges standard or primitive cells 53 as a minimum dimensional unit. In FIGS. 14A and 14B, a hatched area indicates an area in which the standard or primitive cells 53 have been already arranged, and a non-hatched area indicates an area in which the standard or primitive cells 53 are not arranged, that is, a non-hatched area indicates a space.

In the seventh embodiment, fill cells are not located below or in the vicinity of a target wiring 54. The target wiring 54 vertically extends from a gate electrode 55 to which the target wiring 54 is electrically connected.

In operation, the automatic layout system 73 retrieves the standard cells until the automatic layout system 73 finds three spaces located just below or in the vicinity of the target wiring 54, starting from the gate electrode 55 of an inverter cell 56 towards an output driver of the target wiring 54.

Before carrying out retrieval, the automatic layout system 73 defines a region 57 surrounded by a solid line in which a space is to be found.

By carrying out retrieval, the automatic layout system 73 finds a first space 58, a second space 59 and a third space 60 in the region 57.

Then, as illustrated in FIG. 14B, the standard cells 53 located below or in the vicinity of the target wiring 54 are shifted such that a first space 58a, a second space 59a and a third space 60a are located adjacent to the gate electrode 55 of the inverter cell 56. Thus, there is formed a space in which a fill cell is to be positioned.

Then, the automatic layout system 73 inserts a fill cell into the thus formed space to thereby electrically connect the target wiring 54 to the fill cell.

With the connection of the target wiring 54 to the fill cell, a parasitic capacitance of the target wiring 54 is increased. However, since the target wiring 54 has a long wiring length and a great parasitic capacitance, an increase ratio in a parasitic capacitance is quite small relatively to the parasitic capacitance which the target wiring 54 originally had. Hence, an increase in a parasitic capacitance of the target wiring 54 would exert ignorable influence on an operation rate of the semiconductor integrated circuit.

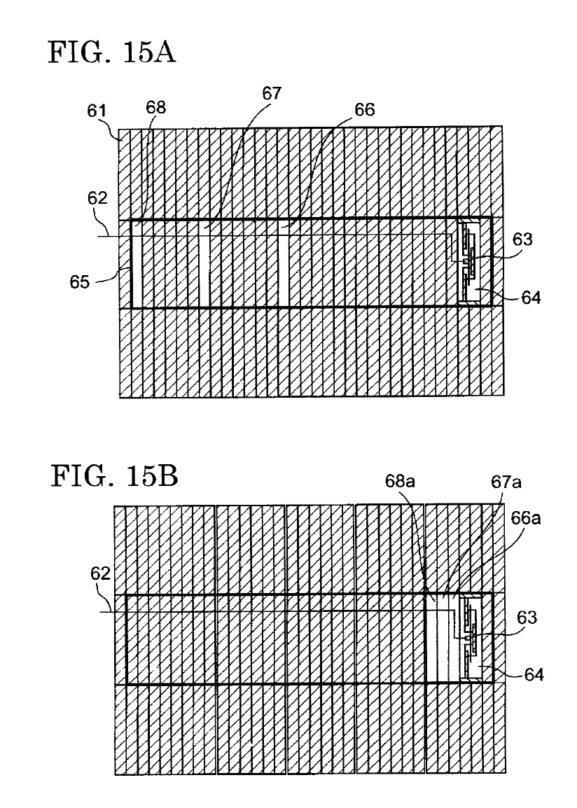

FIGS. 15A and 15B illustrate a semiconductor integrated circuit in accordance with the eighth embodiment of the present invention. FIG. 15A is a plan view of a cell layout of the semiconductor integrated circuit before a countermeasure against the antenna effect is carried out, and FIG. 15B is a plan view of a cell layout of the same after a countermeasure against the antenna effect has been carried out.

In the eighth embodiment, similarly to the seventh embodiment, standard cells are shifted to define a space in a desired area into which a fill cell is to be positioned. FIGS. 15A and 15B are not entire views of a unit of automatic layout, but partial views of the same.

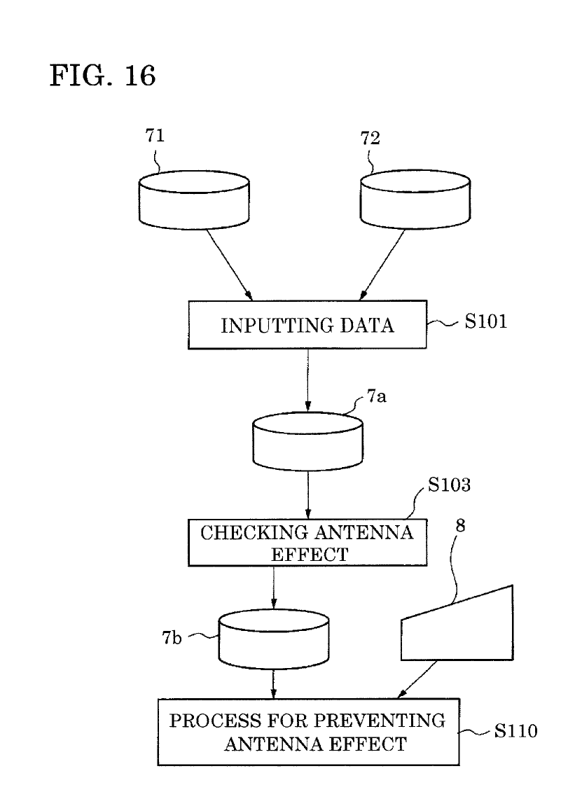

As illustrated in FIG. 16A, the automatic layout system 73 arranges standard or primitive cells 61 as a minimum dimensional unit. In FIGS. 15A and 15B, a hatched area indicates an area in which the standard or primitive cells 61 have been already arranged, and a non-hatched area indicates an area in which the standard or primitive cells 61 are not arranged, that is, a non-hatched area indicates a space.

In the eighth embodiment, fill cells are not located below or in the vicinity of a target wiring 62. The target wiring 62 horizontally extends from a gate electrode 63 to which the target wiring 62 is electrically connected.

In operation, the automatic layout system 73 retrieves the standard cells until the automatic layout system 73 finds three spaces located just below or in the vicinity of the target wiring 62, starting from the gate electrode 63 of an inverter cell 64 towards an output driver of the target wiring 62.

Before carrying out retrieval, the automatic layout system 73 defines a region 65 surrounded by a solid line in which a space is to be found.

By carrying out retrieval, the automatic layout system 73 finds a first space 66, a second space 67 and a third space 68 in the region 65.

Then, as illustrated in FIG. 15B, the standard cells 61 located below or in the vicinity of the target wiring 62 are shifted such that a first space 66a, a second space 67a and a third space 68a are located adjacent to the gate electrode 63 of the inverter cell 64. Thus, there is formed a space in which a fill cell is to be positioned.

Then, the automatic layout system 73 inserts a fill cell into the thus formed space to thereby electrically connect the target wiring 62 to the fill cell.

In accordance with the above-mentioned second to eighth embodiments, it would be possible to accomplish a countermeasure against the antenna effect without an increase in a layout area of LSI, that is, an area of a semiconductor chip.

The reason is as follows. In the above-mentioned second to sixth embodiments, if it is assumed that a target wiring has a maximum wiring length of 2 mm, and a wiring track pitch of 1 μm, 2000 standard or primitive cells having a minimum dimension would exist below the target wiring. If it were assumed that an activity ratio of the primitive cells is 95%, 100 spaces would be formed among the 200 primitive cells. Each of the 100 spaces is equal in size to the primitive cell.

In the present invention, a fill cell is positioned in three or more spaces, but not positioned in one or two spaces. Since there is a high possibility that at least one set of three or more spaces located adjacent to one another, among the 100 spaces, it would be almost possible to insert a fill cell into such spaces.

The above-mentioned possibility could be made higher in dependence on the data 8 indicative of an area in which a fill cell is retrieved, ensuring accomplishing a countermeasure against the antenna effect without an increase in a layout area.

Though a fill cell has a size equal to a total size of three primitive cells in the above-mentioned embodiments, it should be noted that a fill cell may have a size equal to a total size of one, two, four or more primitive cells.

As having been explained with reference to FIG. 6, a fill cell was positioned into a space formed between the standard cells after the standard cells were arranged, in the above-mentioned first embodiment.

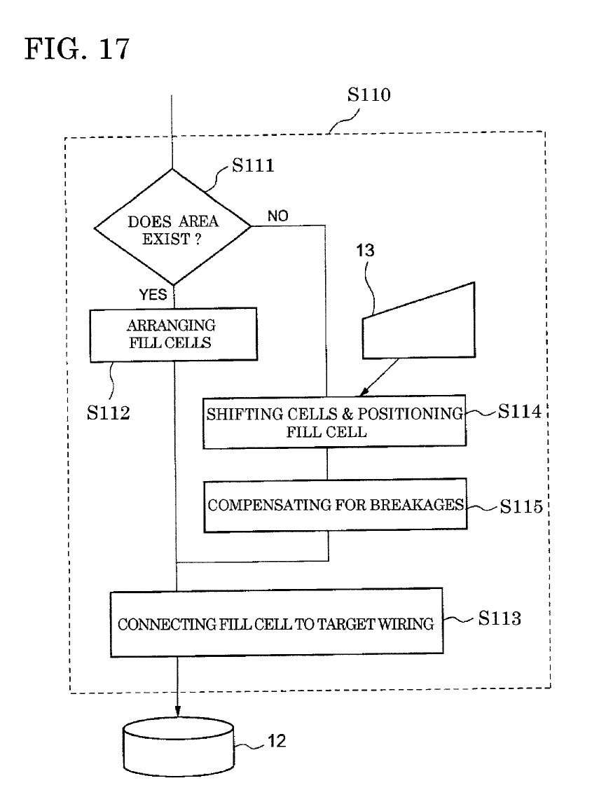

Hereinbelow is explained a variant of the first embodiment with reference to FIGS. 16 and 17 This variant is characterized in that fill cells are arranged after it was checked whether the antenna effect occurred, in comparison with the first embodiment.

With reference to FIG. 16, the first data stored in the first memory 71 and the second data stored in the second memory 72 are input into the automatic layout system 73, in step S101.

If there is formed a space between the standard cells, the automatic layout system 73 positions a fill cell in the space, and transmits layout data 7a.

The electronic design automation tool 74 checks whether there is caused antenna effect in any of wirings, based on the layout data 7a, and transmits check data 7b to the automatic layout system 73, in step S103. The check data 7b identifies a target wiring.

Then, the automatic layout system 73 carries out a process for preventing the antenna effect, to all wirings identified by the check data 7b, in step S110, based on data 8 indicative of a range in which a fill cell is to be retrieved.

The step S110 includes steps 111, 112, 113, 114 and 115.

The automatic layout system 73 checks whether there exists an area in which a fill cell can be positioned, below the target wiring or in the vicinity of the target wiring, based on the data 8, in step S111.

If there is found such an area (YES in step S111), the automatic layout system 73 layouts a fill cell in such an area, in step S112, and electrically connects the fill cell to a target wiring, in step S113.

If there is not found such an area (NO in step S111), data 13 indicative of an area in which a space formed between the standard cells is to be retrieved is input into the automatic layout system 73.

Then, the automatic layout system 73 continues a search until a space to position a fill cell therein is found below the target wiring or in the vicinity of the target wiring, based on the data 13.

Then, the automatic layout system 73 shifts some standard cells to thereby form a space, and positions a fill cell in the thus formed space, in step S114.

Then, the automatic layout system 73 compensates for breakages in wirings caused by shifting the standard cells in step S115, and electrically connects a fill cell and the target wiring to each other in step S113.

Thus, there is obtained mask data 12 relating to layout of the standard cells and wirings to which a countermeasure against the antenna effect was carried out.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-049123 filed on Feb. 25, 2000 including specification, claims, drawings and summary is incorporated herein by reference in its entirety.

What is claimed is:

1. A method of layouting a semiconductor integrated circuit comprised of a plurality of cells, comprising the step of positioning a fill cell at a space formed between said cells, said fill cell including a protection circuit for preventing a wiring electrically connecting said cells to each other from being charged.

2. The method as set forth in claim 1, wherein said protecting circuit is comprised of a diode.

3. The method as set forth in claim 1, wherein said fill cell has a region through which a wiring electrically connecting said cells to each other is arranged.

4. The method as set forth in claim 1, further comprising the steps of:
checking whether there is caused antenna effect due to said wiring being charged, and
electrically connecting a wiring which needs to be protected from said antenna effect, to said protection circuit.

5. The method as set forth in claim 2, wherein a wiring which needs to be protected from antenna effect is electrically connected across said diode and a grounded line.

6. The method as set forth in claim 2, wherein a wiring which needs to be protected from antenna effect is electrically connected across a source voltage line and a grounded line.

7. The method as set forth in claim 1, further comprising the steps of:
forming a cell having an opening pattern through which wirings are electrically connected to each other; and
arranging said cell on said protection circuit.

8. The method as set forth in claim 1, further comprising the step of, if said fill cell is not located in the vicinity of a wiring which needs to be protected from antenna effect, shifting at least one space formed between said cells, to the vicinity of said wiring.

9. A method of layouting a semiconductor integrated circuit comprised of a plurality of cells, comprising the steps of:
(a) inputting first data and second data into an automatic layout system, said first data relating to connection of a circuit, said second data relating to said cells and a fill cell which is to be positioned at a space formed between said cells and includes a protection circuit for preventing a wiring electrically connecting said cells to each other from being charged;
(b) arranging said cells, based on said first and second data;
(c) positioning said fill cell in a space formed between said cells;
(d) checking whether there is caused antenna effect due to said wiring being charged, and transmitting a check signal identifying a wiring which needs to be protected from said antenna effect; and
(e) carrying out a process for preventing said antenna effect, to said wiring identified with said check signal.

10. The method as set forth in claim 9, further comprising the steps of:
(f) checking whether there exists said fill cell below said wiring identified with said check signal or in the vicinity of said wiring; and
(g) connecting said wiring to said fill cell, if said fill cell is judged to exist in said step (f).

11. The method as set forth in claim 9, further comprising the steps of:
(f) checking whether there exists said fill cell below said wiring identified with said check signal or in the vicinity of said wiring;
(g) if said fill cell is judged not to exist in said step (f), retrieving a space in which said fill cell is to be positioned and which is located on said wiring identified with said check signal or in the vicinity of said wiring;
(h) shifting said cell such that said wiring can be connected to said fill cell; and
(i) compensating for breakage in said wiring caused by said step (h).

12. The method as set forth in claim 11, further comprising the step of (j) defining an area in which said space is to be retrieved, said step (j) being to be carried out before said step (g).

13. The method as set forth in claim 12, wherein said area is comprised of a horizontally extending area and a vertically extending area.

14. An apparatus for layouting a semiconductor integrated circuit comprised of a plurality of cells, comprising:
(a) a first memory including first data relating to connection of a circuit;
(b) a second memory including second data relating to said cells and a fill cell which is to be positioned at a space formed between said cells and includes a protection circuit for preventing a wiring electrically connecting said cells to each other from being charged;
(c) an automatic layout system which arranges said cells, based on said first and second data, and positions said fill cell in a space formed between said cells; and
(d) an electronic design automation tool which checks whether there is caused antenna effect due to said wiring being charged, and transmits a check signal identifying a wiring which needs to be protected from said antenna effect;
said automatic layout system carrying out a process for preventing said antenna effect, to said wiring identified with said check signal.

15. The apparatus as set forth in claim 14, wherein said automatic layout system checks whether there exists said fill cell below said wiring identified with said check signal or in the vicinity of said wiring, and connects said wiring to said fill cell, if said fill cell is judged to exist.

16. The apparatus as set forth in claim 14, wherein said automatic layout system (a) checks whether there exists said fill cell below said wiring identified with said check signal or in the vicinity of said wiring, (b) retrieves a space in which said fill cell is to be positioned and which is located on said wiring identified with said check signal or in the vicinity of said wiring, if said fill cell is judged not to exist, (c) shifts said cell such that said wiring can be connected to said fill cell, and (d) compensates for breakage in said wiring caused by shifting said cell.

17. The apparatus as set forth in claim 14, wherein said automatic layout system defines an area in which said space is to be retrieved before actually retrieving said space.

18. The apparatus as set forth in claim 17, wherein said area is comprised of a horizontally extending area and a vertically extending area.

19. A semiconductor integrated circuit comprised of a plurality of cells, comprising:
(a) a semiconductor substrate including protection elements formed therein, said protection elements each comprising a first diffusion layer formed at a surface of said substrate and a second diffusion layer around said first diffusion layer, said first diffusion layer having a first electrical conductivity and said second diffusion layer having a second electrical conductivity;
(b) a grounded line electrically connecting to said second diffusion layer through a contact hole;
(c) a voltage source line electrically connecting to a third diffusion layer formed at a surface of said substrate, through a contact hole, said third diffusion layer having a first electrical conductivity, said grounded line and said voltage source line both being comprised of a first metal wiring layer; and
(d) a target wiring which is comprised of said first metal wiring layer and needs to be protected from antenna effect,
one of said protection elements being located just below said target wiring, said target wiring being electrically connected to said first diffusion layer of said one of protection elements through a contact hole.

20. A semiconductor integrated circuit comprised of a plurality of cells, comprising:
(a) a semiconductor substrate including protection elements formed therein, said protection elements each comprising a first diffusion layer formed at a surface of said substrate and a second diffusion layer around said first diffusion layer, said first diffusion layer having a first electrical conductivity and said second diffusion layer having a second electrical conductivity;
(b) a grounded line electrically connecting to said second diffusion layer through a contact hole;
(c) a voltage source line electrically connecting to a third diffusion layer formed at a surface of said substrate, through a contact hole, said third diffusion layer having a first electrical conductivity, said grounded line and said voltage source line both being comprised of a first metal wiring layer;
(d) a target wiring which is comprised of said first metal wiring layer and needs to be protected from antenna effect, and
(e) a connector wiring having a first end located just above one of said protection elements located in the vicinity of said target wiring, and a second end at which said connector wiring is electrically connected to said target wiring,
said connector wiring being electrically connected at said first end to said first diffusion layer of said one of protection elements through a contact hole.

21. A semiconductor integrated circuit comprised of a plurality of cells, comprising:
(a) a semiconductor substrate including protection elements formed therein, said protection elements each comprising a first diffusion layer formed at a surface of said substrate and a second diffusion layer around said first diffusion layer, said first diffusion layer having a first electrical conductivity and said second diffusion layer having a second electrical conductivity;
(b) a grounded line electrically connecting to said second diffusion layer through a contact hole;
(c) a voltage source line electrically connecting to a third diffusion layer formed at a surface of said substrate, through a contact hole, said third diffusion layer having a first electrical conductivity, said grounded line and said voltage source line both being comprised of a first metal wiring layer;
(d) a target wiring which is comprised of a second metal wiring layer located above said first metal wiring layer, and which needs to be protected from antenna effect; and
(e) a connector wiring comprised of said first metal wiring layer,
at least one of said protection elements being located just below said target wiring, said target wiring being electrically connected to said connector wiring through a first contact hole, and said connector wiring being electrically connected to said first diffusion layer of said one of protection elements through a second contact hole.

22. A semiconductor integrated circuit comprised of a plurality of cells, comprising:
(a) a semiconductor substrate including protection elements formed therein, said protection elements each comprising a first diffusion layer formed at a surface of said substrate and a second diffusion layer around said first diffusion layer, said first diffusion layer having a first electrical conductivity and said second diffusion layer having a second electrical conductivity;
(b) a grounded line electrically connecting to said second diffusion layer through a contact hole;
(c) a voltage source line electrically connecting to a third diffusion layer formed at a surface of said substrate, through a contact hole, said third diffusion layer having a first electrical conductivity, said grounded line and said voltage source line both being comprised of a first metal wiring layer;
(d) a target wiring which is comprised of a second metal wiring layer located above said first metal wiring layer, and which needs to be protected from antenna effect; and
(e) a connector wiring which is comprised of said first metal wiring layer and which has a first end located just below said target wiring and a second end located just above one of said protection elements,
said connector wiring being electrically connected at said first end to said target wiring through a first contact hole, and being electrically connected at said second end to said first diffusion layer of said one of protection elements through a second contact hole.

23. A semiconductor integrated circuit comprising:
(a) a plurality of macro cells;
(b) a target wiring which needs to be protected from antenna effect and which electrically connects a driver cell located in one of said macro cells to a gate electrode cell located in another one of said macro cells,
said target wiring passing through a space defined between said macro cells, said space being filled with fill cells each including a protection circuit for preventing antenna effect,
said target wiring being electrically connected to a fill cell located closest to said gate electrode cell.
